(19) United States
(12) Patent Application Publication
(10) Pub. No.: US 2024/0076476 A1
(43) Pub. Date: Mar. 7, 2024

(54) PLASTICIZED CELLULOSE ESTER COMPOSITIONS WITH IMPROVED WEATHERING AND ARTICLES FORMED THEREFROM

(71) Applicant: Eastman Chemical Company, Kingsport, TN (US)

(72) Inventors: Michael Eugene Donelson, Kingsport, TN (US); Robert Erik Young, Kingsport, TN (US); David Wayne Compton, Weber City, VA (US); Everett Bryston Shepard, Nickelsville, VA (US)

(73) Assignee: Eastman Chemical Company, Kingsport, TN (US)

(21) Appl. No.: 17/754,658

(22) PCT Filed: Oct. 8, 2020
(86) PCT No.: PCT/US2020/054704

§ 371 Date: Apr. 8, 2022

Related U.S. Application Data
(60) Provisional application No. 62/913,290, filed on Oct. 10, 2019.

(51) Int. Cl. C08L 1/14; C08K 5/11; C08K 5/3475

(52) U.S. Cl. CPC C08L 1/14; C08K 5/11; C08K 5/3475; C08K 2201/019; C08L 2201/08; C08L 2203/16

(57) ABSTRACT

Disclosed is a plasticized cellulose ester composition. The plasticized cellulose ester composition of the present invention includes at least one cellulose ester; a plasticizer system including one or more aliphatic plasticizers; and a benzotriazole ultraviolet absorber. A flooring article with at least one layer formed from the composition is also described.

### FIELD OF THE INVENTION

The present invention generally relates to plasticized cellulose ester compositions as well as articles formed from said compositions.

### BACKGROUND OF THE INVENTION

As the chemical industry and consumers look for environmentally friendly alternatives to certain chemicals, the growth of cellulose esters has increased significantly. Cellulose esters are plant-based compounds derived from cellulose, a polysaccharide found in wood, plants and plant products such as cotton. Cellulose esters have been used in a wide variety of consumer and industry end-product uses such as coatings and coating ingredients, objects such as eyeglass frames, disposable knives, forks, spoons, plates, cups and straws, toothbrush handles automotive trim, camera parts and disposable syringes. Cellulose esters also have intermediate and B2B product uses, often in the form of fibers, films, sheets and the like. Published studies indicate that the cellulose esters market is projected to grow from USD 9.27 billion in 2018 to USD 12.43 billion by 2023, at a CAGR of 6% from 2018 to 2023, with the coatings market projected to lead the growth.

Despite this growth, it acknowledged in the art that challenges exist in utilizing cellulose esters in certain applications. For example, it is noted in U.S. Published Patent Application No. 2016/0068656 that, while cellulose esters are generally considered environmentally-friendly polymers and are derived from renewable sources like wood pulp, they have not been widely used in plastic compositions due to processing difficulties. The '656 application continues by referencing the absence of cellulose esters in injection molded articles and assert that this absence is due, at least in part, to the narrow temperature window between the melting point and the decomposition temperature of cellulose esters. The fact that production of film and sheet with cellulose esters has historically been limited to standard extrusion and solvent casting methods is also discussed in WO2018017652A1, assigned to the assignee of the present invention.

As evidenced by the description of above-referenced WO2018017652A1 as well as WO2018/089591A1, also assigned to the assignee of the present invention, Applicant is actively pursuing innovations which facilitate use of environmentally-friendly cellulose esters in various end-use applications. One end-use application of particular interest is so-called “resilient” flooring products that historically include vinyl sheet flooring, vinyl composite tile, luxury vinyl tile, rubber and linoleum. In this market, polyvinylchloride is a popular material but recently has encountered lower popularity due to environmental concerns. Accordingly, consumers and therefore product manufacturers seek alternative materials of construction.

A particular challenge for materials used in flexible flooring applications is weatherability. During shipping and storage, and particularly after installation, flooring materials, and in particular the top or wear layer of multilayer flooring materials, may be exposed to significant electromagnetic energy, particularly in the ultraviolet range (UV) typically bracketed between 280 nm and 400 nm, that is generated from direct sunlight, indirect sunlight passing through windows and artificial light generated for example by fluorescent or LED lighting. This exposure can result in discoloration, fading and yellowing of the flooring as well as development of a visually detectable haze. These phenomena, generally categorized as weathering, reduce a consumer's satisfaction with the product and inevitably shorten the product's useful life. By way of example in this field, U.S. Pat. No. 6,572,956 describes a weatherable multilayer resinous article and method for its preparation.

In addition to weatherability, flooring articles must also satisfy other attributes that are critical for commercial success or may also be required to meet governmental standards for use. For example, flooring articles must often meet certain standards of fire safety or flammability. Further, especially with regard to a multilayer flooring article, the top or wear layer must remain substantially transparent while still minimizing the transmission of ultraviolet energy to other layers, in particular an underlying layer which may carry a printed design or image (often called a print layer), which could be damaged by UV.

Despite advances in the technology, a continuing unmet need remains for a composition useful in flooring applications that employs environmentally-friendly materials while exhibiting processing, weatherability, ultraviolet transmission, flammability and other performance characteristics comparable to if not exceeding that of polyvinyl chloride flooring.

### SUMMARY OF THE INVENTION

In a first aspect, the present invention relates to a plasticized cellulose ester composition including at least one cellulose ester; a plasticizer system comprising one or more aliphatic plasticizers; and a benzotriazole ultraviolet absorber.

In another aspect, the present invention relates to a calendered article including at least one cellulose ester; a plasticizer system comprising one or more aliphatic plasticizers; and a benzotriazole ultraviolet absorber.

In yet another aspect, the present invention is directed to a flooring article including at least one layer, wherein the layer includes at a plasticized cellulose ester composition including least one cellulose ester; one or more aliphatic plasticizers; and a benzotriazole ultraviolet absorber.

Further aspects of the invention are as disclosed and claimed herein.

### DETAILED DESCRIPTION

For avoidance of doubt, it is expressly provided for that the information and descriptions herein regarding features or elements of one aspect of the present invention are asserted as applicable to and are relied on to also support those features and elements when described with regard to other aspects of the invention.

In a first aspect, the present invention is directed to a plasticized cellulose ester composition. The plasticized cellulose ester composition of this aspect of the present invention includes at least one cellulose ester; a plasticizer system including one or more aliphatic plasticizers; and a benzotriazole ultraviolet absorber.

As used herein, the term “aliphatic” in describing a plasticizer means compounds with carbon atoms that form linear, open chains or are cyclic but without carbon-bond interactions as with aromatic rings. Non-limiting examples of aliphatic plasticizers suitable for the present invention include bis(2-ethylhexyl) adipate (DOA); dioctyl adipate, triethylene glycol bis(2-ethylhexanoate) (TEG-EH), dihexyl azelate, triethyl citrate, acetyl triethyl citrate, triacetin, tripropionin, tributyrin and polymeric adipates such as commercially available under the trade names Admex 523, Admex 525, Admex 6995, Admex 761, Admex 910-001, Admex 6187, Admex 770 and Admex 760, and combinations thereof. In one or more embodiments, the aliphatic plasticizer is selected from the group consisting of aliphatic esters such triethylene glycol bis(2-ethylhexanoate) (TEG-EH), bis(2-ethylhexyl) adipate (DOA), dioctyl adipate and combinations thereof. In one or more embodiments, the aliphatic plasticizer is triethylene glycol bis(2-ethylhexanoate) (TEG-EH). The term “system” used in describing a plasticizer system is intended to include a singular plasticizer as well as combinations of two or more plasticizers.

An important feature of the present invention is the unexpected synergistic effect of aliphatic plasticizers when compared to aromatic plasticizers on weatherability of compositions and articles when used in combination with benzotriazole ultraviolet absorbers. Accordingly, in one or more embodiments, the plasticizer system includes at least 60% by weight or at least 65% by weight or at least 70% by weight or at least 75% by weight or at least 80% by weight or at least 85% by weight or at least 90% by weight or at least 92% by weight or at least 94% by weight or at least 96% by weight or at least 98% by weight or 100% by weight aliphatic plasticizer based on the total weight of the plasticizer system. In one or more embodiments, the plasticizer system is a plasticizer system consisting of or consisting essentially of one or more aliphatic plasticizers. In one or more embodiments, the composition of the present invention is substantially free of aromatic plasticizers. As used herein, the term “aromatic” in describing a plasticizer means a compound containing a planar unsaturated ring of carbon atoms that is stabilized by interaction of the bonds forming the ring, sometimes called resonance bonds. Examples of aromatic plasticizers include aromatic diesters such as tris(2-Ethylhexyl) trimellitate (TOTM), phosphate esters such as resorcinol bis(diphenylphosphate (RDP), bisphenol A bis(diphenylphosphate) (BDP), bis-xylenylphosphate (RXP), triphenyl phosphate, aryl phosphate (SOL-DP), tricresyl phosphate, cresyl diphenyl phosphate, 2-Ethylhexyl diphenyl phosphate and phthalate plasticizers such as dioctyl phthalate, dibutyl phthalate.

In one or more embodiments, the plasticized cellulose ester composition includes from 5% to 35% by weight or from 10% to 30% by weight of said plasticizer system based on the total weight of said composition.

The plasticized cellulose ester composition of the present invention includes at least one cellulose ester. A cellulose ester is generally defined to include cellulose esters of one or more carboxylic acids and are described for example in U.S. Pat. No. 5,929,229, assigned to the assignee of the present invention, the contents and disclosure of which are incorporated herein by reference. Non limiting examples of cellulose esters include cellulose acetate, cellulose propionate, cellulose butyrate, so-called mixed acid esters such as cellulose acetate propionate and cellulose acetate butyrate, and combinations thereof. In one or more embodiments, the at least one cellulose ester is chosen from cellulose acetate, cellulose acetate propionate, or cellulose acetate butyrate and combinations thereof. In one or more embodiments, the cellulose ester is cellulose acetate. In one or more embodiments, the at least one cellulose ester is cellulose acetate propionate. In one or more embodiments, the at least one cellulose ester is cellulose acetate butyrate. In one or more embodiments, the at least one cellulose ester is a combination of cellulose acetate propionate and cellulose acetate butyrate.

In one or more embodiments, the amount of the at least one cellulose ester in the plasticized cellulose ester composition is between 25% and 99% by weight, or between 35% and 95%, or between 45% and 95%, all based on the total weight of the plasticized cellulose ester composition.

The cellulose ester of the present invention may be characterized using one or more characteristics. For example, in one or more embodiments, the cellulose ester may have a number average molecular weight (“Mn”) that is in the range of from 20,000 Da to 100,000 Da. In one or more embodiments, the cellulose ester has a Mn that is in the range of from about 20,000 Da to about 80,000 Da.

The cellulose ester may have in one or more embodiments a solution ball-drop viscosity of 2 to 30 or 4 to 25 or 5 to 20 seconds as measured by ASTM D817.

The cellulose ester may have in one or more embodiments a degree of substitution of the hydroxyl substituent (DSOH) of from 0.1 to 1.0, or a degree of degree of substitution of the acetyl (DSAC) of from 0.1 to 0.8. By way of brief background, DSOH and DSAC are measures of the degree of esterification for a given cellulose ester. Cellulose has three hydroxyls per anhydroglucose unit, located at the C2, C3 and C6 carbons, that can be esterified to varying degrees and in different ratios with various acyl groups, with the type of cellulose ester formed depending on the functionalization of the hydroxyl groups. For cellulose triacetate, for example, in which substantially all hydroxyl groups of the cellulose functionalized with acetyl groups, the degree of substitution of the acetyl (“DSAC”) can be approximately 2.90, and the degree of substitution of the hydroxyl (“DSOH”) can be approximately 0.10. Cellulose diacetate has a DSAC of approximately 2.5 and a DSOH of approximately 0.5.

The cellulose ester may in one or more embodiments have a glass transition temperature (Tg) of 50° C. to 150° C. or from 70° C. to 120° C. or no more than 160° C.

The cellulose ester may in one or more embodiments have a percent crystallinity of less than 20% or less than 15% or less than 10% or less than 5% or from 5% to 10% or from 5% to 15% or from 5% to 20% or from 10% to about 20%. Crystallinity is described herein using, and measured in the context of the present invention from, the second heat cycle in accordance with ASTM D3418 and assuming an enthalpy of melting of 14 cal/g for the cellulose esters. In this method, the amount of crystallinity is measured under a prescribed heating history, more particularly the “2^{nd} cycle” cooling and heating in a DSC per ASTM D3418. In this method, the sample is first heated in the DSC to above its melting temperature to erase any prior crystallinity (i.e. the “first heat cycle”). Next the sample is cooled at 20 degrees C. per minute to below Tg, and then reheated at the same rate to above the melting temperature again (the “2^{nd} heat cycle”). During this cooling and 2^{nd} heating, the material will recrystallize to a certain degree, and this amount of crystallization is measured in the scan as the enthalpy of melting at the melting temperature.

The composition of the present invention includes a benzotriazole ultraviolet absorber. Benzotriazole ultraviolet absorbers are a class of chemical compounds and compound derivatives containing a benzotriazole moiety and which absorb electromagnetic radiation in the ultraviolet range. Benzotriazole ultraviolet absorbers and methods for their manufacture are described for example in U.S. Pat. No. 3,629,191, the contents and disclosure of which are incorporated herein by reference. Benzotriazole ultraviolet absorbers are commercially available, for example from BASF Corporation under the trade name TINUVIN™ and Solvay Group under the trade name CYASORB™. Examples of benzotriazole ultraviolet absorbers include without limitation include benzotriazole (BTA), 2-(2-Hydroxy-5-t-octylphenyl)-benzotriazole, 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″, 4″, 5″, 6″-tetrahydrophthalimide methyl)-5′-methylphenyl)benzotriazole, 2,2-methylenebis(4-(1,1,3,3,-tetramethylbutyl)-6-(2H-benzotriazole-2-yl) phenol), 2-(2′-hydroxy-3′-tert-butyl-5′-methylphenyl)-5-chlorobenzotriazole, 2-(2′-hydroxy-3′-tert-butyl-5′-(2-octyloxycarbonylethyl)-phenyl)-5-chlorobenzotriazole and 2-(2′-hydroxy-3′-(1-methyl-1-phenylethyl)-5′-(1,1,3,3,-tetramethylbutyl)-phenyl)benzotriazole and combinations thereof.

In one or more embodiments of the present invention, said benzotriazole ultraviolet absorber is present in an amount of 0.05% to 1.5% by weight or from 0.25% to 1% by weight or at least 0.25% by weight based on the total weight of said composition. It will be appreciated by one or ordinary skill in the art, however, that lesser amounts of benzotriazole ultraviolet absorber may be utilized in the present invention, in particular when other non-benzotriazole ultraviolet absorbers are included.

As discussed above, an important feature of the present invention is the unexpected synergistic effect of aliphatic plasticizers, especially when compared to aromatic plasticizers, on [long-term] weatherability of compositions and articles when used in combination with benzotriazole ultraviolet absorbers. This unexpected synergistic effect may be evidenced by measurements from one or more tests known in the art for demonstrating and quantitatively measuring the weatherability of compositions and related articles as generally evidenced by color change. In one or more embodiments, the present invention may exhibit one or more of (a) a b* color measurement change (Ab) of no more than 1.25 or no more than 1.0 or no more than 0.8 units as measured in accordance with ASTM E1164-12 when subjected to 3,147 hours accelerated weathering in accordance with ASTM D-4674 Method IV; (b) a total color change (ΔE) of no more than 0.5 or no more than 0.4 or no more than 0.3 units as measured in accordance with ASTM D2244 when subjected to 3,147 hours accelerated weathering in accordance with ASTM D-4674 Method IV; and (c) a yellowness index change (ΔY) of no more than 2.0 or no more than 1.75 or no more than 1.5 units as measured in accordance with ASTM E313 when subjected to 3,147 hours accelerated weathering in accordance with ASTM D-4674 Method IV. In one or more embodiments, the present invention may exhibit a b* color measurement change (Δb) of no more than 1.25 or no more than 1.0 or no more than 0.8 units as measured in accordance with ASTM E1164-12 when subjected to 3,147 hours accelerated weathering in accordance with ASTM D-4674 Method IV. In one or more embodiments, the present invention may exhibit a total color change (ΔE) of no more than 0.5 or no more than 0.4 or no more than 0.3 units as measured in accordance with ASTM D2244 when subjected to 3,147 hours accelerated weathering in accordance with ASTM D-4674 Method IV. In one or more embodiments, the present invention may exhibit a yellowness index change (ΔY) of no more than 2.0 or no more than 1.75 or no more than 1.5 units as measured in accordance with ASTM E313 when subjected to 3,147 hours accelerated weathering in accordance with ASTM D-4674 Method IV. In one or more embodiments, the present invention may exhibit one or more of (a) a b* color measurement change (Δb) of no more than 0.3 or no more than 0.25 or no more than 0.2 units as measured in accordance with ASTM E1164-12 when subjected to 1,647 hours accelerated weathering in accordance with ASTM D-4674 Method IV; (b) a total color change (ΔE) of no more than 0.3 or no more than 0.25 or no more than 0.2 units as measured in accordance with ASTM D2244 when subjected to 1,647 hours accelerated weathering in accordance with ASTM D-4674 Method IV; and (c) a yellowness index change (AY) of no more than 0.5 or no more than 0.45 or no more than 0.4 units as measured in accordance with ASTM E313 when subjected to 1,647 hours accelerated weathering in accordance with ASTM D-4674 Method IV. In one or more embodiments, the present invention may exhibit two or more, or three or more, or four of the above-described Δb, ΔE and ΔY characteristics.

In addition to the above, the present invention may in one or more embodiments exhibit a haze change (ΔH) of no more than 2.8 or no more than 2.7 or no more than 2.6 units as measured in accordance with ASTM D1003-13 when subjected to 3,147 hours accelerated weathering in accordance with ASTM D-4674 Method IV. In addition to the above, the present invention may in one or more embodiments exhibit a haze change (ΔH) of no more than 0.5 or no more than 0.4 or no more than 0.3 units as measured in accordance with ASTM D1003-13 when subjected to 1,647 hours accelerated weathering in accordance with ASTM D-4674 Method IV.

In addition to the above, the present invention may exhibit an ultraviolet transmission percent (for a film of 20 mil thickness) of no more than 2% or no more than 1% or no more than 0.5% or no more than 0.25% or no more than 0.10% or no more than 0.05% or no more than 0.04% or no more than 0.03% or no more than 0.02% between the wavelengths of 300 nm and 350 nm.

One or ordinary skill will appreciate that the above characteristics are typically measured on samples in sheet or film form. Accordingly, the compositions of the present invention exhibit these characteristics when formed into a film or sheet. In one or more embodiments, the compositions of the present invention exhibit these characteristics when formed into a film or sheet suitable for use as a layer of a flooring article. The thickness of films or sheets suitable for use as a layer of a flooring article will vary depending on the type of flooring article and, if a multilayer, the location and function of the specific layer. Sheet thickness is typically between 3 mils and 500 mils for the laminated structure, or between 1 mil and 40 mils for the top wear layer.

The composition of the present invention may further include one or more of processing aids, impact modifiers and roll release agents. In one or more embodiments, the plasticized cellulose ester composition of the present invention may include at least one roll release agent. Suitable roll release agents are known in the art and are described for example in U.S. Pat. No. 6,551,688, the contents and disclosure of which are incorporated herein by reference. Examples of suitable roll release agents include without limitation lubricants, waxes such as amide waxes, fatty acids, fatty acid esters, fatty acid salts, saponified fatty acid salts and combinations thereof. Examples of a fatty acid esters include esters of montanic acid. In one or more embodiments, the roll release agent is a fatty acid ester selected from the group consisting of butylene glycol ester of montanic acid, glycerol ester of montanic acid, pentaerythryitol ester of montanic acid and combinations thereof.

When included in the present invention, the at least one roll release agent is typically present in an amount of 0.1% to about 2.0% by weight based on the total weight of the composition. In one or more embodiments, the at least one roll release agent is present in an amount of 0.1% to 1.0% by weight based on the total weight of the composition. In one or more embodiments, the at least one roll release agent is present in an amount of 0.1% to 0.5% by weight based on the total weight of the composition. In one or more embodiments, the at least one roll release agent is present in amount of 0.5% to 1.0% by weight based on the total weight of the composition. In one or more embodiments, the at least one roll release agent is present in an amount of 1.0% to 2.0% by weight based on the total weight of the composition. In one or more embodiments, the at least one roll release agent is present in an amount of 1.5% to 2.0% by weight based on the total weight of the composition.

The present invention may further include at least one processing aid. Processing aids may for example improve the texture and “fusion” of the melt, improve melt strength, reduce composition melting time, reduce overall processing time and help with metal release from calendering rolls. Processing aids are known in the art and may be derived for example from acrylics, and acrylic copolymers although processing aids based on styrenics, carbonates, polyesters, other olefins, and siloxanes are known and commercially available. Suitable processing aids are commercially available and include without limitation Paraloid™ K-125 available from Dow; Kane-Ace® PA-20, PA-610, B622, MR01 and MP90 available from Kaneka Corporation; and Ecdel™ available from Eastman Chemical Company. In one or more embodiments, the at least one processing aid includes one or more of acrylic polymer, an acrylic copolymer, a styrenic polymer, a carbonate polymer, a polyester polymer, an olefin polymer and a siloxane polymer. In one or more embodiments, the at least one processing aid is selected from the group consisting of an acrylic polymer or an acrylic copolymer. In one embodiment, the processing aid comprises a Kane-Ace® acrylic processing aid.

The amount of the at least one processing aid present in the present invention may vary depending on, the type of processing aid and its molecular weight and viscosity, the other components of the composition and the composition's end-use application. In one or more embodiments, the at least one processing aid is present in an amount of 0% to about 3.0% by weight based on the total weight of the composition. In one or more embodiments, the at least one processing aid is present in an amount of 0.1% to 6.0% by weight based on the total weight of the composition. In one or more embodiments, the at least one processing aid is present in an amount of 0.5% to 6.0% by weight based on the total weight of the composition. In one or more embodiments, the processing aid is present in an amount of 0.5% to 3.0% by weight based on the total weight of the composition.

The present invention may also include at least one impact modifier. Examples of impact modifiers include core-shell polymers based on acrylics, including acrylic polymers, methacrylate butadiene styrene (MBS) polymers, silicone-acrylic polymers and combinations thereof. Other suitable impact modifiers include acrylonitrile-butadiene styrene (ABS), ethylene vinyl acetate copolymers, chlorinated polyethylenes, ethylene copolymers and combinations thereof. The at least one impact modifier, if present, is typically present in an amount of 1% to about 20% by weight based on the total weight of the composition.

The composition of the present invention may further include one or more other ingredients or components such as for example fillers such as calcium carbonate, flame retardants, lubricants, pigments, dispersing aids, biocides, antistatic agents, water repelling additives, rodenticides, dyes, colorants and the like.

In one or more embodiments, the composition of the present invention is suitable for or capable of forming a calendered article such as for example a sheet or film. Accordingly, in an aspect, the present invention relates to a calendered article comprising or formed from a plasticized cellulose ester composition that includes at least one cellulose ester; a plasticizer system comprising one or more aliphatic plasticizers; and a benzotriazole ultraviolet absorber. As previously noted, information and description set forth in regard to features and elements of the plasticized cellulose ester composition aspect of the present invention or other aspects are intended to be applicable to and fully support this calendered article aspect.

By use of the phrase “calendered article” the present invention intends to describe articles such as films or sheets formed using a calendering method with a molten polymer wherein the molten polymer is forced through the nips of counterrotating rolls to form a film or sheet, gradually squeezed down to a film or sheet of final thickness by optionally passing through additional rolls having a similar counterrotating arrangement (with the roll arrangements typically referred to as a “stack”); subjecting the film or sheet to additional treatment, such as for example stretching, annealing, slitting or the like and then winding the formed article on a winder. Calendering and calendered articles as used herein are described in more detail in U.S. Published Patent Application No. 2019/0256674, assigned to the assignee of the present invention, the contents and disclosure of which are incorporated herein by reference.

In one or more of these embodiments, the plasticized cellulose ester composition has a melt viscosity according to ASTM 3835 of 1000 Poise to 5000 Poise or 2000 Poise to 5000 Poise at a temperature of 90° C. and a shear rate of 628 s⁻¹. In one or more of these embodiments, the plasticized cellulose ester composition of the present invention is capable of being calendered at the temperature range of the sum of the glass transition temperature of the cellulose ester of the composition minus 20° C. to the sum of the glass transition temperature of the cellulose ester of the composition plus 50° C. With a view toward these embodiments, an aspect of the present invention is a calendered article formed from the plasticized cellulose ester composition of the present invention, in particular wherein the calendered article is a film, a sheet or layer of a multilayer article.

Though the preceding aspect of the present invention describes a utility of the plasticized cellulose ester composition of the present invention in the field of calendering and calendered articles, one of ordinary skill in the art will appreciate that the composition of the present invention may also be useful in forming articles by other known methods, such as for example extrusion, injection molding, blow-molding, additive manufacturing (3D printing), profile extrusion, blown film, multilayer film, sheet lamination and the like.

The plasticized cellulose ester composition of the present invention may be useful in forming a flooring article, a calendered flooring article or more particularly a layer of a flooring article or a calendered layer of a flooring article. Accordingly, in another aspect, the present invention is directed to a flooring article. The flooring article of this aspect of the present invention includes at least one layer. In one or more embodiments, the at least one layer is a calendered layer. In one or more embodiments, the at least one layer is formed from the plasticized cellulose ester composition of the present invention. Accordingly, the at least one layer includes a plasticized cellulose ester composition that includes at least one cellulose ester; a plasticizer system comprising one or more aliphatic plasticizers; and a benzotriazole ultraviolet absorber. Flooring articles contemplated as within the scope of present invention include without limitation any material or construction intended for use as, installation on or application to a walking surface or lower surface of a room or building. Non-limiting examples of flooring articles include rolled flooring, squares, tiles, planks, sheet, laminates and the like which may be installed for example as a so-called “floating” floor or a glued-down floor assembly. As previously noted, information and description set forth in regard to features and elements of the plasticized cellulose ester composition aspect or other aspects of the present invention are applicable to and intended to fully support this aspect directed to flooring articles.

In one or more embodiments, the flooring article is a resilient flooring article. In one or more embodiments, the resilient flooring article is a multilayer resilient flooring article or a laminated flooring article. An example multilayer flooring article may include without limitation a top or wear layer, a base or core layer and a printable or print layer between the top or wear layer and the base or core layer. The top or wear layer provides scratch and abrasion resistance while also allowing for visibility through the top surface of any underlying print layer design and typically has a thickness of between 15 mils and 25 mils. The base or core layer provides dimensional stability and typically has a thickness of at least 75 mils. The printable layer may provide a visual color and/or design, for example in the form of geometric patterns or images, and typically has a thickness of between 3 mils and 5 mils. Multilayer flooring articles on the type contemplated herein are generally well known in the art and are described for example in U.S. Pat. No. 8,071,193, the contents and disclosure of which are incorporated herein by reference.

In one or more embodiments, the flooring article of the present invention may be a multilayer resilient flooring article including a top or wear layer and the at least one layer is the top or wear layer of the multilayer flooring article. Typically, the top or wear layer of a multilayer flooring article is a layer with significant exposure to ultraviolet radiation, such as for example from sunlight or indoor fluorescent or LED lighting. Accordingly, in one or more embodiments, the at least one layer is a top or wear layer of a multilayer flooring article. As noted above, however, multilayer flooring may further include a base or core layer and a printable layer between the top or wear layer and the base or core layer and it will be appreciated that layers other than the top layer may benefit from the unexpectedly superior weatherability achieved by the present invention. Accordingly, in one or more embodiments, the present invention is a multilayer flooring article including a top or wear layer, a base or core layer and a printable layer between the top or wear layer and the base or core layer and the at least one layer is a printable layer of the multilayer flooring article. Similarly, in one or more embodiments, the present invention may be a multilayer flooring article including a top or wear layer, a base or core layer and a printable layer between the top or wear layer and the base or core layer, and the least one layer is the base or core layer of the multilayer flooring article. In one or more embodiments, the at least one layer is a calendered layer or a calendered sheet or a calendered film.

The following examples, while provided to illustrate with specificity and detail the many aspects and advantages of the present invention, are not be interpreted as in any way limiting its scope. Variations, modifications and adaptations which do depart from the spirit of the present invention will be readily appreciated by one of ordinary skill in the art.

To demonstrate the present invention, samples of an inventive composition were formulated to include a cellulose ester, an aliphatic plasticizer and a benzotriazole ultraviolet absorber. These are labeled as 156-2, 156-3 and 156-4 in Table 1 below. Two types of control compositions were also formulated for comparison. One set of control compositions included a cellulose ester and an aromatic plasticizer: one sample in this set did not include a benzotriazole ultraviolet absorber (Sample 156-5) and four from this set included varying amounts of a benzotriazole ultraviolet absorber (Samples 156-6 through 156-9). Another control material (Sample 156-1) included a cellulose ester and an aliphatic plasticizer and no benzotriazole UV absorber. Component amounts are indicated in Table 1 in weight percent based on the total weight of the composition.

TABLE 1

| Sample | Description |
|---|---|
| 156-1 | CAP 482 + 22% TEG2EH + 0% Cyasorb 5411 |
| 156-2 | CAP 482 + 22% TEG2EH + 0.25% Cyasorb 5411 |
| 156-3 | CAP 482 + 22% TEG2EH + 0.5% Cyasorb 5411 |
| 156-4 | CAP 482 + 22% TEG2EH + 1.0% Cyasorb 5411 |
| 156-5 | CAP 482 + 22% RDP + 0% Cyasorb 5411 |
| 156-6 | CAP 482 + 22% RDP + 0.25% Cyasorb 5411 |
| 156-7 | CAP 482 + 22% RDP + 0.5% Cyasorb 5411 |
| 156-8 | CAP 482 + 22% RDP + 1.0% Cyasorb 5411 |
| 156-9 | CAP 482 + 22% SOL-DP + 0% Cyasorb 5411 |

With regard to the components in Table 1: CAP 482 is a high viscosity Cellulose Acetate Propionate available from Eastman Chemical Company with a solution ball-drop viscosity of 20 seconds as measured by ASTM D817; TEG2EH is triethylene glycol bis(2-ethylhexanoate), an aliphatic plasticizer available from Eastman Chemical Company; RDP is resorcinol bis(diphenyl phosphate), an aromatic plasticizer/flame retardant available from ICL-IP under the name Fyroflex™ RDP. SOL-DP is a proprietary aromatic plasticizer/flame retardant also offered by ICL-IP, with a melting point range of 101° C. to 108° C. and plasticizing effects at processing temperatures; and Cyasorb™ 5411 is 2-(2-Hydroxy-5-t-octylphenyl)-benzotriazole, a benzotriazole ultraviolet absorber sold by Solvay Group.

To form each of the above formulations, the individual components were compounded on a Leistritz 18 mm multizone twin screw extruder with zone temperatures varying from feed zone temperature of 90° C. progressing to 220° C. at the vent and die. The screw speed was medium shear design and varied from 500 to 575 rpm. From each formulation, films of 20 mil thickness were pressed on a Carver press at temperatures of 190° C. to 200° C. and pressures up to 15,000 psi.

Film samples as formed above were optically tested per the analytical methods below to establish baseline (t=0) values for comparison and then subjected to accelerated weathering using a SolarEye weathering device having UV fluorescent bulbs with a peak irradiance at 351 nm and following method ASTM D 4674 Method IV. The samples were oriented vertically for the duration of the test. Samples were exposed for 3,147 hours with optical properties measured at an intermediate exposure of 1,647 hours as well as the termination of the exposure time (3,147 hours). Film samples were also tested for ultraviolet absorption via measurement of ultraviolet transmission through the sample.

### Analytical Methods

As is conventional in the art, optical tests known in the art for measuring color and haze were used to assess and quantitatively measure weatherability. Color data was obtained using a Hunter Lab UltraScan Spectrophotometer (Model 8000) in reflectance mode and with a D65 Illuminant* (Daylight, Noon World Average, ˜6500° K correlated color temp). Color was measured directly to measure L*, a*, and b* values, total color change (ΔE*) (ASTM D2244) as well as Yellowness Index (Y) (ASTM E313). Haze (H) was measured using HunterLab UltraScan Spectrophotometers (Model 8000) in Transmittance Mode using a D65 Light Source (Daylight, Noon World Average, 6500° K color temperature), 10⁰ standard observer, the Large Area View (1″ diameter) and with the Specular Included. Haze data was collected according to ASTM D1003. Higher b*, E and yellowness and haze numbers correspond to increased color and haze as a result of the exposure to accelerated weathering.

Testing for change in ultraviolet transmission of the 20 mil samples was performed on a PerkinElmer Lambda 850 UV/VIS Spectrometer. Wavelengths at the shorter wavelength end of the ultraviolet region were of particular focus as they have relatively higher energy and are more likely to penetrate wear layers and cause damage to print layers. Wavelength scans were collected from 300 nm to 350 nm using a 1 nm data interval and a scan speed of 266.75 nm/min. Measurements were performed and data generated in the “% Transmission” mode using a beam attenuator. The light sources used were a deuterium source for wavelengths up to 319.2 nm and a tungsten halogen source for wavelengths over 319.2 nm. The detection system used a photomultiplier tube with a detector slit width of 2 nm and a detector response of 0.2 secs.

The results of the optical and UV absorption testing are set forth in Tables 2 and 3 below respectively.

TABLE 2

| | | | | |
|---|---|---|---|---|
| Sample | | | Change in | |
| Number | Delta b* | Delta YI | Delta E | Delta Haze |

Change in optical properties as function
of exposure to 3147 hours

| | | | | |
|---|---|---|---|---|
| 156-1 | 0.8 | 1.5 | 0.8 | 0.6 |
| 156-2 | ND | ND | ND | ND |
| 156-3 | 0.1 | 0.2 | 0.2 | −1.2 |
| 156-4 | 0.1 | 0.2 | 0.2 | −1.2 |
| 156-5 | 3.9 | 7.0 | 4.0 | 4.1 |
| 156-6 | 1.5 | 2.6 | 1.5 | 0.3 |
| 156-7 | 1.0 | 1.7 | 1.0 | −1.1 |
| 156-8 | 0.5 | 0.8 | 0.5 | −0.3 |
| 156-9 | 5.9 | 11.2 | 52.7 | 55.2 |

Change in optical properties as function
of exposure to 1647 hours

| | | | | |
|---|---|---|---|---|
| 156-1 | 0.3 | 0.5 | 0.3 | 0.5 |
| 156-2 | −0.1 | −0.1 | 0.1 | −0.4 |
| 156-3 | 0.1 | 0.1 | 0.1 | −1.1 |
| 156-4 | 0.0 | 0.0 | 0.1 | −1.0 |
| 156-5 | 1.5 | 2.6 | 1.5 | 0.5 |
| 156-6 | 0.5 | 0.9 | 0.5 | 0.0 |
| 156-7 | 0.3 | 0.6 | 0.4 | −0.5 |
| 156-8 | 0.1 | 0.2 | 0.1 | −0.1 |
| 156-9 | 3.6 | 6.8 | 5.2 | 62.4 |

TABLE 3

| | Transmission as a function of Wavelength (nm) | | | | | |
|---|---|---|---|---|---|---|
| Sample | 300 | 310 | 320 | 330 | 340 | 350 |
| 156-1 | 56.50 | 63.37 | 67.90 | 70.51 | 73.01 | 76.38 |
| 156-2 | 0.02 | 0.01 | 0.05 | 0.03 | 0.01 | 0.02 |
| 156-3 | 0.01 | 0.01 | 0.03 | 0.02 | 0.01 | 0.01 |
| 156-4 | 0.00 | 0.00 | 0.02 | 0.01 | 0.00 | 0.01 |
| 156-5 | 44.64 | 50.65 | 54.34 | 56.02 | 57.66 | 60.25 |
| 156-6 | 0.02 | 0.02 | 0.04 | 0.03 | 0.02 | 0.01 |
| 156-7 | 0.01 | 0.01 | 0.04 | 0.02 | 0.01 | 0.01 |
| 156-8 | 0.00 | 0.00 | 0.02 | 0.02 | 0.01 | 0.01 |
| 156-9 | 50.04 | 59.68 | 63.80 | 67.09 | 69.58 | 71.87 |

As demonstrated in the above Table 2, the present invention unexpectedly demonstrated long-term weatherability (as measured by color change and haze) superior to all controls. Particularly surprising was the superiority of the weatherability of the samples with a benzotriazole ultraviolet absorber plus a plasticizer system of an aliphatic plasticizer (numbers 156-2, 156-3 and 156-4) when compared with samples with the same amounts of a benzotriazole ultraviolet absorber plus a plasticizer system of aromatic plasticizer (numbers 156-6, 156-7, 156-8 and 156-9). It was noted that sample 156-2 became sufficiently brittle at the end of the exposure period so as to preclude optical testing; therefore, optical testing values were not determined (indicated in Table 2 as “ND”).

As demonstrated in above Table 3, the improved weatherability demonstrated in Table 2 was achieved without detriment to ultraviolet absorption performance that is critical for resilient flooring, in particular for top or wear layers of resilient multilayer flooring with a print layer below the wear layer.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

That which is claimed is:

1. A plasticized cellulose ester composition, said composition comprising at least one cellulose ester; a plasticizer system comprising one or more aliphatic plasticizers; and a benzotriazole ultraviolet absorber.

2. The composition of claim 1 wherein said composition comprises from 10% to 35% by weight of said plasticizer system based on the total weight of said composition.

3. The composition of claim 2 wherein said composition comprises from 15% to 30% by weight of said plasticizer system based on the total weight of said composition.

4. The composition of claim 1 wherein said composition comprises from 0.05% to 1.5% by weight of said benzotriazole ultraviolet absorber based on the total weight of said composition.

5. The composition of claim 4 wherein said composition comprises from 0.25% to 1.0% by weight of said benzotriazole ultraviolet absorber based on the total weight of said composition.

6. The composition of claim 1 wherein said composition further comprises one or more of roll release agents, processing aids, impact modifiers, fillers such as calcium carbonate, flame retardants, lubricants, pigments, dispersing aids, biocides, antistatic agents, water repelling additives, rodenticides, dyes and colorants.

7. The composition of claim 1 wherein said at least one cellulose ester is selected from the group consisting of cellulose acetate propionate and cellulose acetate butyrate and combinations thereof.

8. The composition of claim 1 wherein said one or more aliphatic plasticizers is selected from the group consisting of bis(2-ethylhexyl) adipate (DOA); dioctyl adipate, triethylene glycol bis(2-ethylhexanoate) (TEG-EH), dihexyl azelate, triethyl citrate, acetyl triethyl citrate, triacetin, tripropionin, tributyrin, polymeric adipates and combinations thereof.

9. The composition of claim 1 wherein said composition, when formed into a film or sheet suitable for use as a layer of a flooring article exhibits one or more of (a) a b* color measurement change (Ab) of no more than 1.25 units as measured in accordance with ASTM E1164-12 when subjected to 3,147 hours accelerated weathering in accordance with ASTM D-4674 Method IV; (b) a total color change (ΔE) of no more than 0.25 units as measured in accordance with ASTM D2244 when subjected to 3,147 hours accelerated weathering in accordance with ASTM D-4674 Method IV; and (c) a yellowness index change (ΔY) of no more than 2.0 units as measured in accordance with ASTM E313 when subjected to 3,147 hours accelerated weathering in accordance with ASTM D-4674 Method IV.

10. The composition of claim 9 wherein said composition, when formed into a film or sheet suitable as a layer of a flooring article exhibits a haze change (ΔH) of no more than 2.8 units as measured in accordance with ASTM D1003-13 when subjected to 3,147 hours accelerated weathering in accordance with ASTM D-4674 Method IV.

11. The composition of claim 9 wherein a film or sheet of said composition at a thickness of 20 mils exhibits an ultraviolet transmission of no more than 0.1%.

12. A flooring article comprising at least one layer, said layer comprising a plasticized cellulose ester composition comprising at least one cellulose ester; a plasticizer system comprising one or more aliphatic plasticizers; and a benzotriazole ultraviolet absorber.

13. The flooring article of claim 12 wherein said at least one layer is a top or wear layer of a multilayer flooring article.

14. The flooring article of claim 13 wherein said layer exhibits one or more of (a) a b* color measurement change (Δb) of no more than 1.25 units as measured in accordance with ASTM E1164-12 when subjected to 3,147 hours accelerated weathering in accordance with ASTM D-4674 Method IV; (b) a total color change (ΔE) of no more than 0.25 units as measured in accordance with ASTM D2244 when subjected to 3,147 hours accelerated weathering in accordance with ASTM D-4674 Method IV; and (c) a yellowness index change (ΔY) of no more than 2.0 units as measured in accordance with ASTM E313 when subjected to 3,147 hours accelerated weathering in accordance with ASTM D-4674 Method IV.

15. The flooring article of claim 13 wherein said layer exhibits a haze change (ΔH) of no more than 2.8 units as measured in accordance with ASTM D1003-13 when subjected to 3,147 hours accelerated weathering in accordance with ASTM D-4674 Method IV.

16. The flooring article of claim 13 wherein said layer at a thickness of 20 mils exhibits an ultraviolet transmission of no more than 0.1%.

17. The flooring article of claim 12 wherein said at least one layer does not include an aromatic plasticizer.

18. The flooring article of claim 13 wherein said at least one layer is a calendered film or a calendered sheet.

19. A calendered article comprising a plasticized cellulose ester composition, said composition comprising at least one cellulose ester; a plasticizer system comprising one or more aliphatic plasticizers; and a benzotriazole ultraviolet absorber.

20. The calendered article of claim 19 wherein said calendered article is a sheet or film.
